(19) United States
(12) Patent Application Publication
(10) Pub. No.: US 2024/0066456 A1
(43) Pub. Date: Feb. 29, 2024

(54) Air Scrubber

(71) Applicant: Mullet Tools, LLC, Dripping Springs, TX (US)

(72) Inventor: Jacob Lee Hillard, Plainville, KS (US)

(21) Appl. No.: 18/202,895

(22) Filed: May 27, 2023

Related U.S. Application Data
(60) Provisional application No. 63/365,472, filed on May 27, 2022.

(51) Int. Cl. B01D 46/58; B01D 46/00; B01D 46/10

(52) U.S. Cl. CPC B01D 46/58; B01D 46/0049; B01D 46/10; B01D 2265/028; B01D 2271/022; B01D 2273/30

(57) ABSTRACT

An air scrubber having an outer shell, the outer shell having a first sidewall with a first aperture, a second sidewall with a second aperture, a third sidewall with a third aperture, and a fourth sidewall with a fourth aperture. Each of the apertures are configured to engage a filter. The air scrubber includes a fan configured to move air inward through each of the apertures and through the associated filters to filter contaminants from the air.

### CROSS-REFERENCE TO RELATED APPLICATION

This application claims the benefit of U.S. Provisional Application No. 63/365,427, filed May 27, 2022, which is hereby incorporated by reference in its entirety

### FIELD

The present disclosure relates generally to air filters and air scrubbers configured to filter contaminants from the air.

### BACKGROUND

Air filters and air scrubbers may be used to filter air. Aspects of this disclosure relate to improved air filters and air scrubbers.

### BRIEF SUMMARY

According to one aspect, an air scrubber is disclosed. According to another aspect, an air scrubber includes an outer shell. The outer shell may include a first sidewall having a first aperture; a second sidewall having a second aperture; a third sidewall having a third aperture; a fourth sidewall; a top wall; and a bottom wall. The air scrubber can also include a first filter cover configured to engage the first sidewall and substantially cover the first aperture; a second filter cover configured to engage the second sidewall and substantially cover the second aperture; a third filter cover configured to engage the third sidewall and substantially cover the third aperture. Finally, the air scrubber may also include a fan engaged with the top wall and configured to move air inward through each of the first aperture, the second aperture, and the third aperture and outward from the top wall.

The outer shell of the air scrubber may be formed of single integral piece, and the outer shell may be rotomolded. In some examples, the top wall can be recessed below a top edge of the first, second, third, and fourth sidewalls. The fourth sidewall can include cord retainer configured to retain an electrical cord. The fourth sidewall and or the bottom wall may be engaged with at least one foot.

According to another example, an air scrubber is disclosed. The air scrubber can include an outer shell having a first sidewall having a first aperture, the first aperture having a top edge, a bottom edge, a left edge, and a right edge; a second sidewall having a second aperture, the second aperture a top edge, a bottom edge, a left edge, and a right edge; a third sidewall having a third aperture, the third side wall having a top edge, a bottom edge, a left edge, and a right edge; a fourth sidewall having a fourth aperture, the fourth aperture having a top edge, a bottom edge, a left edge, and a right edge; and a top wall; a bottom wall. Each of the first aperture, the second aperture, the third aperture, and the fourth aperture have a height, width, and depth configured to engage a filter. The top wall of the air scrubber can be recessed below a top edge of the first sidewall, a top edge of the second sidewall, a top edge of the third sidewall, a top edge of the fourth sidewall.

The air scrubber can include a first aperture cover configured to engage the first sidewall and substantially cover the first aperture; a second aperture cover configured to engage the second sidewall and substantially cover the second aperture; a third aperture cover configured to engage the third sidewall and substantially cover the third aperture; and a fourth aperture cover configured to engage the fourth sidewall and substantially cover the fourth aperture. The first aperture cover; the second aperture cover; the third aperture cover; and the fourth aperture cover can be made of an ethylene propylene diene monomer rubber material.

The air scrubber can include a fan engaged with the top wall and configured to move air inward through each of the first aperture, the second aperture, the third aperture, and the fourth aperture outward through the top wall.

The air scrubber can also include a first lip extending from the first sidewall, the first aperture cover configured to engage the first lip; a second lip extending from the second sidewall, the second aperture cover configured to engage the second lip; a third lip extending from the third sidewall, the third aperture cover configured to engage the third lip; and a fourth lip extending from the fourth sidewall, the fourth aperture cover configured to engage the fourth lip.

The air scrubber can also include a first clip configured to removably engage a filter within the first aperture; a second clip configured to removably engage a filter within the second aperture; a third clip configured to removably engage a filter within the first aperture; and a fourth clip configured to removably engage a filter within the first aperture.

The air scrubber can also include a first gasket engaged with the first sidewall and configured to engage a filter engaged in the first aperture; a second gasket engaged with the second sidewall and configured to engage a filter engaged in the second aperture; a third gasket engaged with the third sidewall and configured to engage a filter engaged in the third aperture; and a fourth gasket engaged with the fourth sidewall and configured to engage a filter engaged in the fourth aperture.

The air scrubber outer shell can be molded as a single integral piece and in some examples the air scrubber outer shell can be rotomolded. One or more of the first sidewall, the second sidewall, the third sidewall, and the fourth sidewall can include a handle. The air scrubber can also include cord retainer configured to retain an electrical cord. The air scrubber of bottom wall can also include at least one foot. The air scrubber can have a weight in the range of 10 lbs. to 20 lbs.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and not limited in the accompanying figures in which like reference numerals indicate similar elements and in which:

FIG. 1 depicts a top isometric view of an example air scrubber, according to one or more aspects described herein.

FIG. 2 depicts a top isometric view of the outer shell of the example air scrubber of FIG. 1, according to one or more aspects described herein.

FIG. 3 depicts a bottom isometric view of the example air scrubber of FIG. 1, according to one or more aspects described herein.

FIG. 4 depicts a bottom isometric view of the outer shell of the example air scrubber of FIG. 1, according to one or more aspects described herein.

FIG. 5 depicts a top view of the example air scrubber of FIG. 1, according to one or more aspects described herein.

FIG. 6 depicts a top isometric view of an example air scrubber, according to one or more aspects described herein.

FIG. 7 depicts a front view of the example air scrubber of FIG. 6, according to one or more aspects described herein.

FIG. 8 depicts a back view of the example air scrubber of FIG. 6, according to one or more aspects described herein.

FIG. 9 depicts a side view of the example air scrubber of FIG. 6, according to one or more aspects described herein.

FIG. 10 depicts a side view of the example air scrubber of FIG. 6, according to one or more aspects described herein.

FIG. 11 depicts a top view of the example air scrubber of FIG. 6, according to one or more aspects described herein.

FIG. 12 depicts a bottom view of the example air scrubber of FIG. 6, according to one or more aspects described herein.

FIG. 13 depicts a top isometric view of an example air scrubber, according to one or more aspects described herein.

FIG. 14 depicts a bottom isometric view of the example air scrubber of FIG. 13, according to one or more aspects described herein.

FIG. 15 depicts a front view of the example air scrubber of FIG. 13, according to one or more aspects described herein.

FIG. 16 depicts a top view of the example air scrubber of FIG. 13, according to one or more aspects described herein.

FIG. 17 depicts a side view of the example air scrubber of FIG. 13, according to one or more aspects described herein.

FIG. 18 depicts a side view of the example air scrubber of FIG. 13, according to one or more aspects described herein.

FIG. 19 depicts a back view of the example air scrubber of FIG. 13, according to one or more aspects described herein.

FIG. 20 depicts a bottom view of the example air scrubber of FIG. 13, according to one or more aspects described herein.

FIG. 21 depicts a top isometric view of the example air scrubber of FIG. 13 with the filters removed, according to one or more aspects described herein.

FIG. 22 depicts a bottom isometric view of the example air scrubber of FIG. 13 with the filters removed, according to one or more aspects described herein.

FIG. 23 depicts a front view of the example air scrubber of FIG. 13 with the filters removed, according to one or more aspects described herein.

FIG. 24 depicts a top view of the example air scrubber of FIG. 13 with the filters removed, according to one or more aspects described herein.

FIG. 25 depicts a side view of the example air scrubber of FIG. 13 with the filters removed, according to one or more aspects described herein.

FIG. 26 depicts a side view of the example air scrubber of FIG. 13 with the filters removed, according to one or more aspects described herein.

FIG. 27 depicts a back view of the example air scrubber of FIG. 13 with the filters removed, according to one or more aspects described herein.

FIG. 28 depicts a bottom view of the example air scrubber of FIG. 13 with the filters removed, according to one or more aspects described herein.

FIG. 29A depicts a front isometric view of the example aperture cover for an air scrubber, according to one or more aspects described herein.

FIG. 29B depicts a back isometric view of the example aperture cover for an air scrubber, according to one or more aspects described herein.

FIG. 30 depicts a top isometric view of the example air scrubber of FIG. 13 including aperture covers, according to one or more aspects described herein.

FIG. 31 depicts a bottom isometric view of the example air scrubber of FIG. 13 including aperture covers, according to one or more aspects described herein.

FIG. 32 depicts a front view of the example air scrubber of FIG. 13 including aperture covers, according to one or more aspects described herein.

FIG. 33 depicts a top view of the example air scrubber of FIG. 13 including aperture covers, according to one or more aspects described herein.

FIG. 34 depicts a side view of the example air scrubber of FIG. 13 including aperture covers, according to one or more aspects described herein.

FIG. 35 depicts a side view of the example air scrubber of FIG. 13 including aperture covers, according to one or more aspects described herein.

FIG. 36 depicts a back view of the example air scrubber of FIG. 13 including aperture covers, according to one or more aspects described herein.

FIG. 37 depicts a bottom view of the example air scrubber of FIG. 13 including aperture covers, according to one or more aspects described herein.

FIG. 38 depicts an exploded isometric view showing components of an example air scrubber, according to one or more aspects described herein.

Further, it is to be understood that the drawings may represent the scale of different components of various examples; however, the disclosed examples are not limited to that particular scale.

### DETAILED DESCRIPTION

While this invention is susceptible of embodiments in many different forms, there are shown in the drawings and will herein be described in detail exemplary embodiments of the invention with the understanding that the present disclosure is to be considered as an exemplification of the principles of the invention and is not intended to limit the broad aspects of the invention to the embodiments illustrated. It is to be understood that other embodiments may be utilized, and structural and functional modifications may be made, without departing from the scope and spirit of the present disclosure.

In the following description of the various embodiments, reference is made to the accompanying drawings, which form a part hereof, and in which is shown by way of illustration, various embodiments of the disclosure that may be practiced. It is to be understood that other embodiments may be utilized.

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” “upward,” “downward,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

In general, aspects of this disclosure relate to systems of air filters and air scrubbers. According to various aspects and embodiments, the air scrubber may be formed of one or more of a variety of materials, such as metals (including metal alloys), plastics, polymers, and composites, and may be formed in one of a variety of configurations, without departing from the scope of the invention.

The various figures in this application illustrate examples of air scrubbers according to this disclosure. When the same reference number appears in more than one drawing, that reference number is used consistently in this specification and the drawings to refer to the same or similar parts throughout.

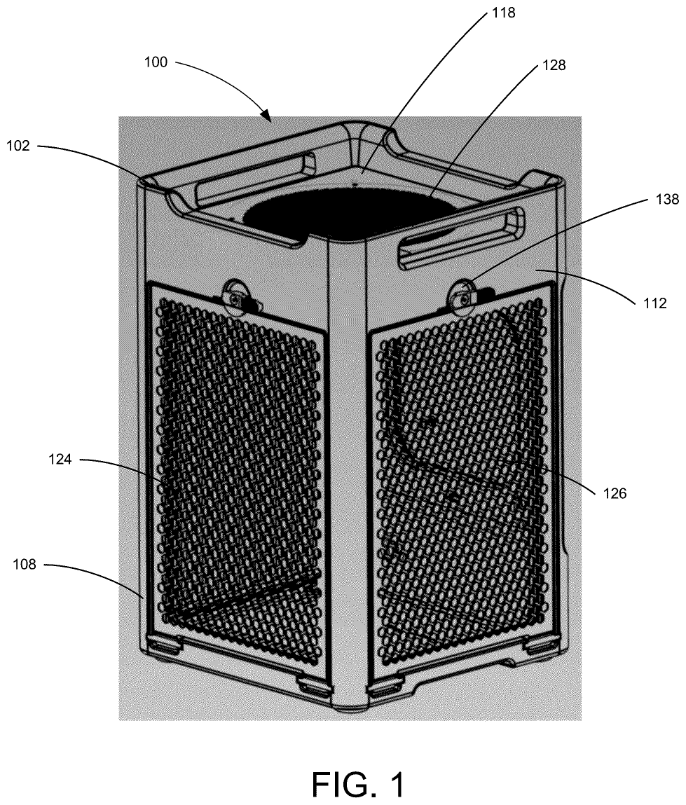

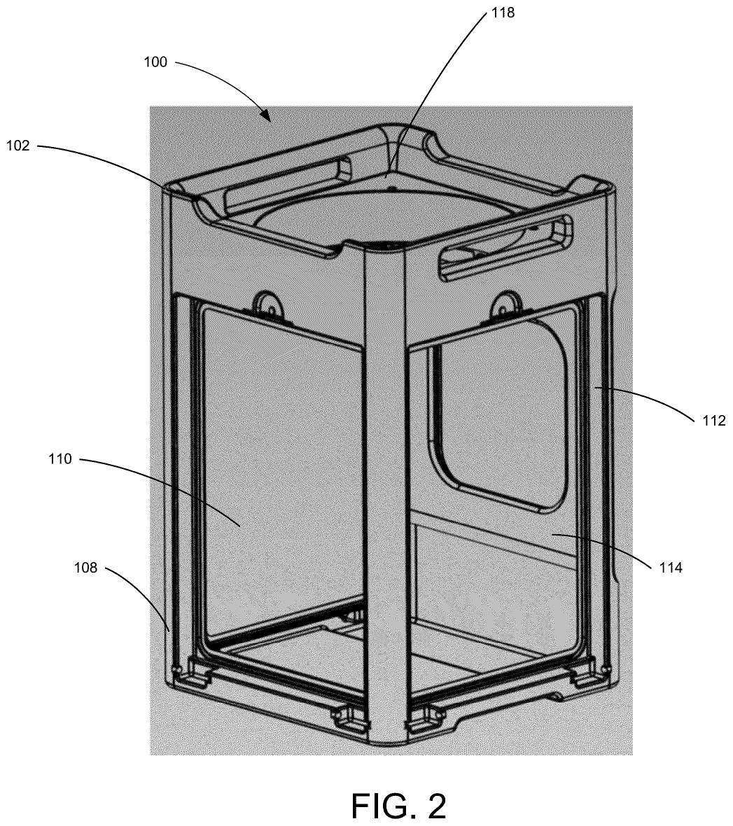

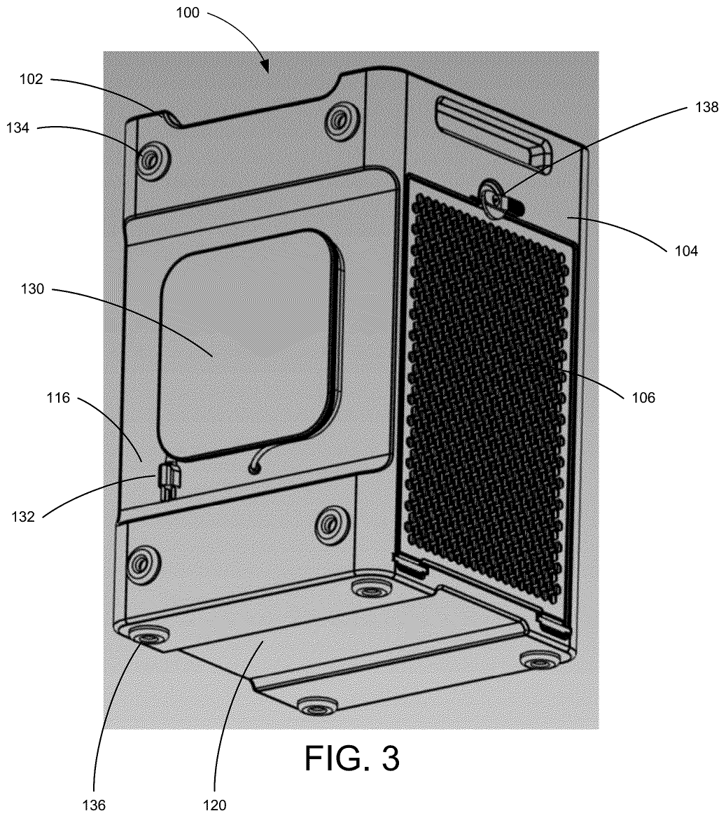

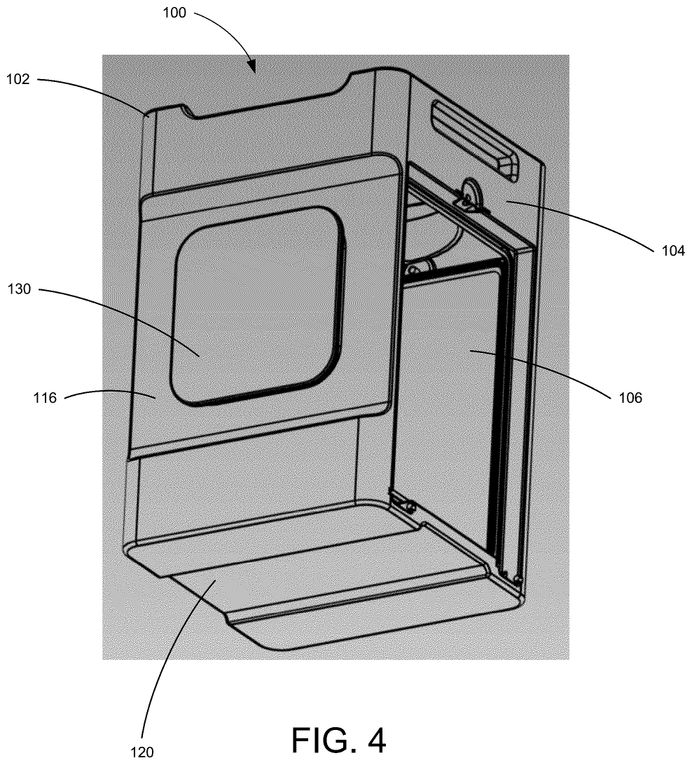

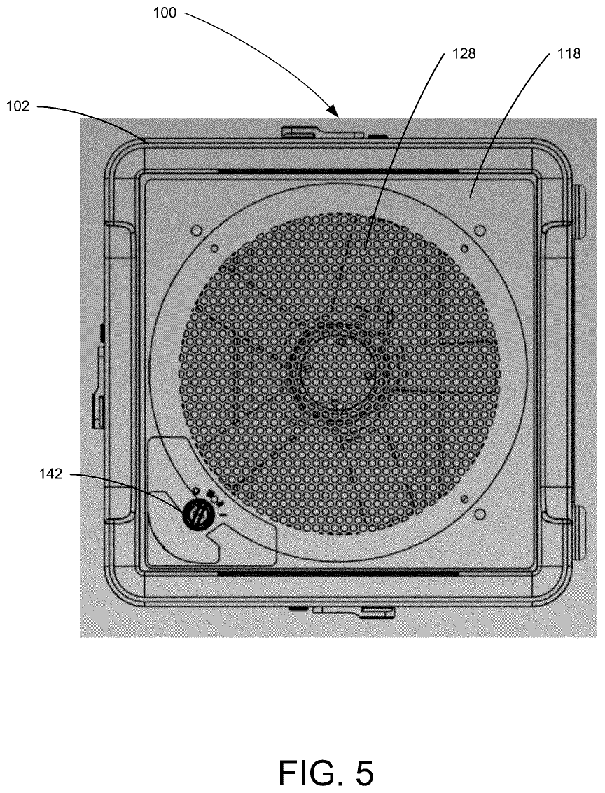

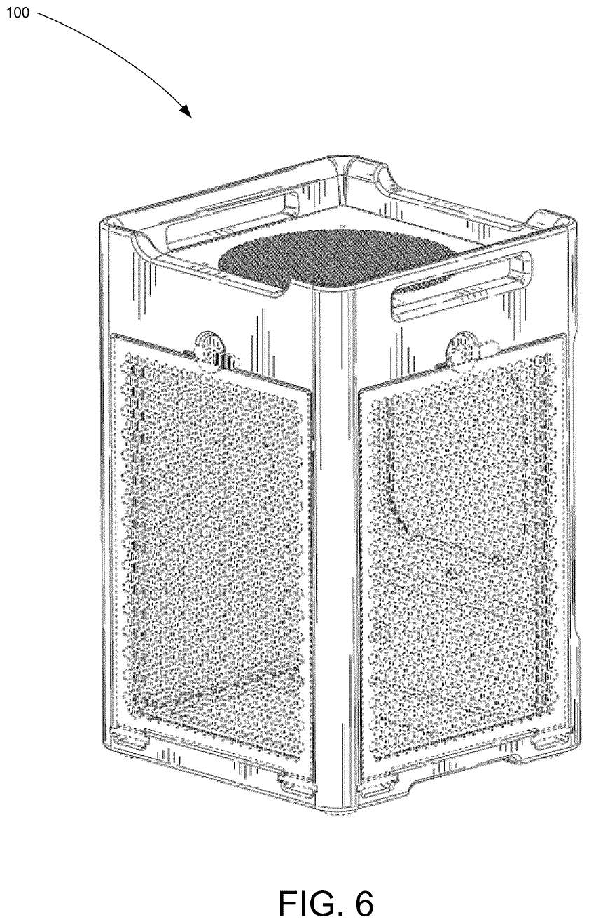

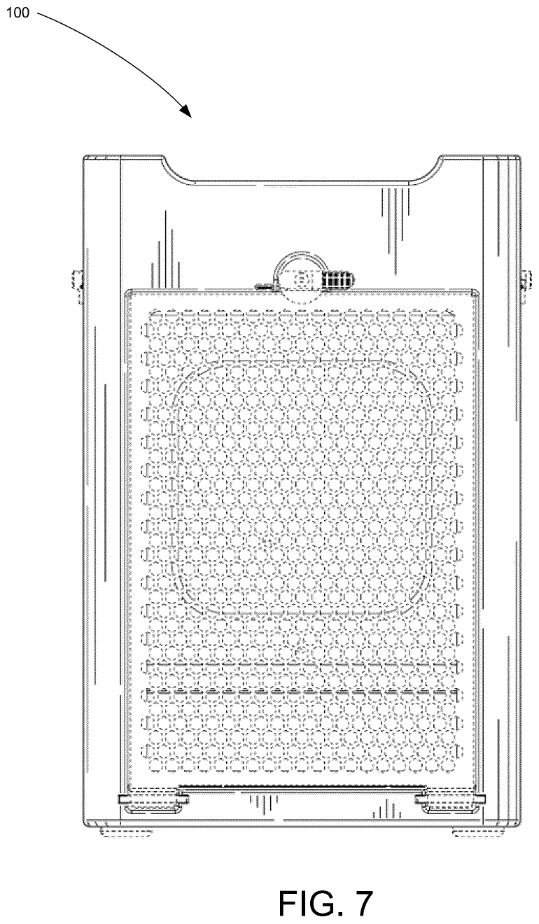

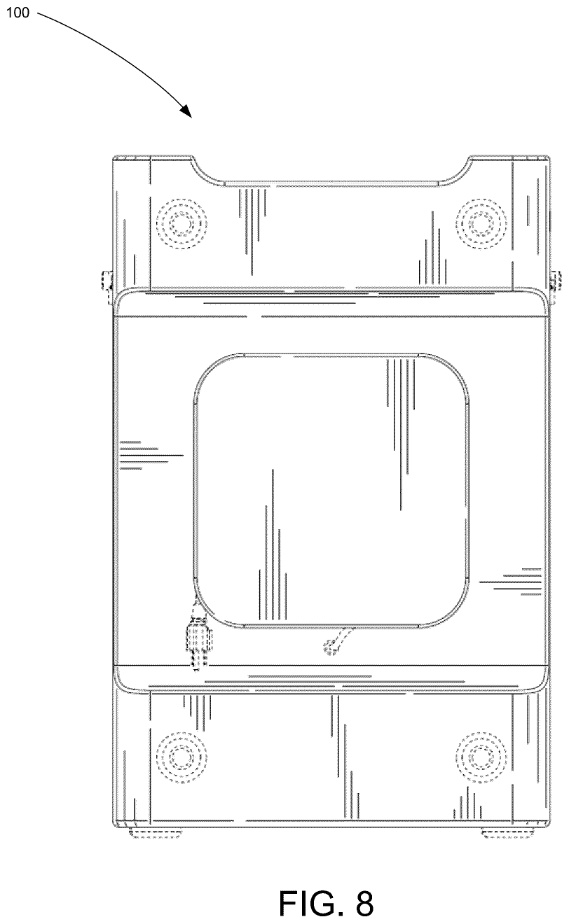

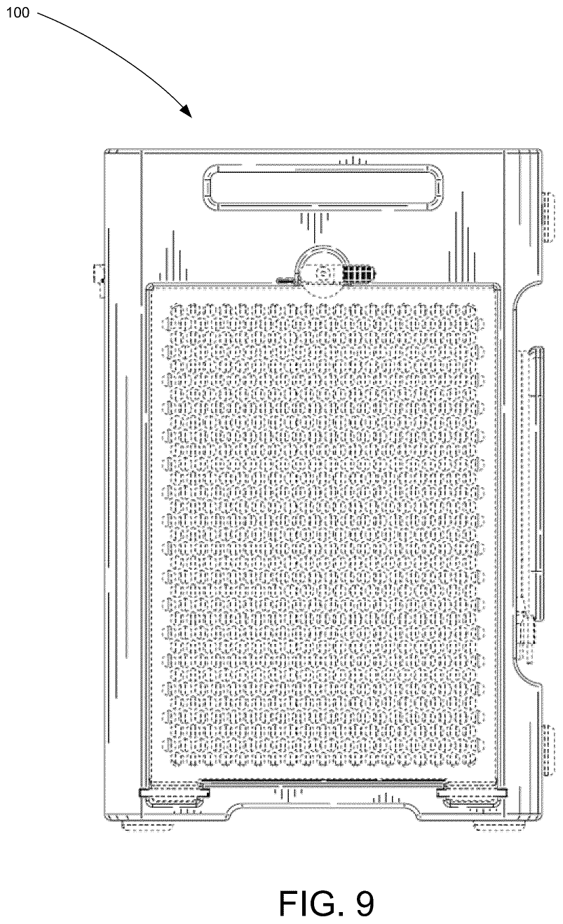

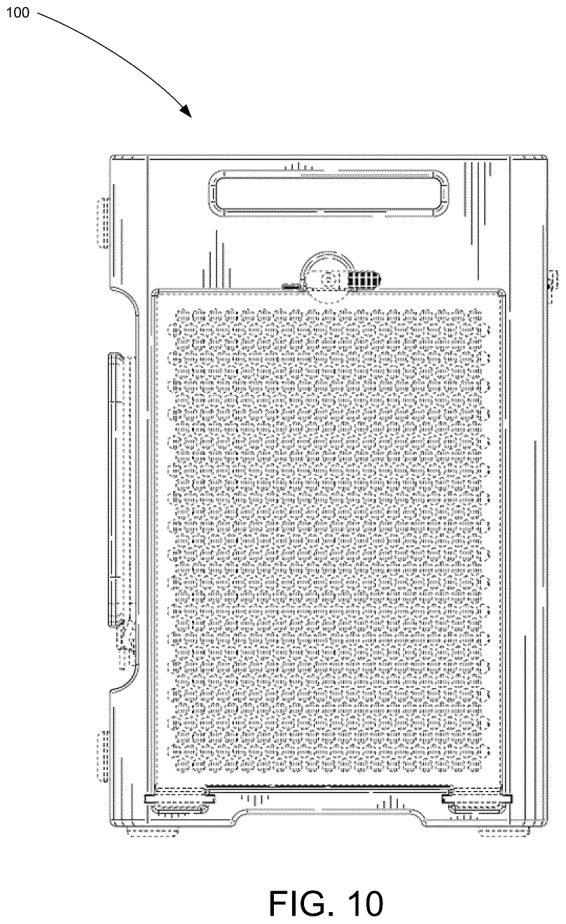

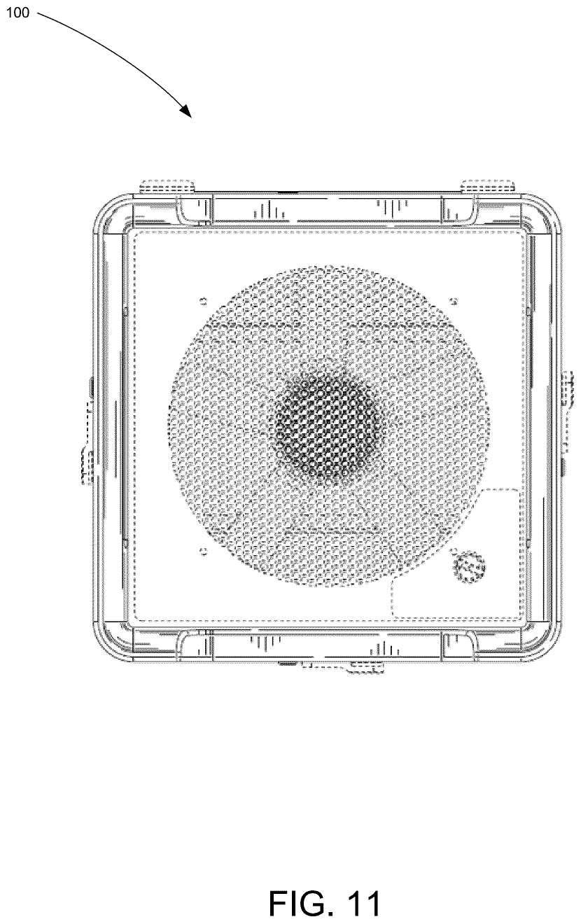

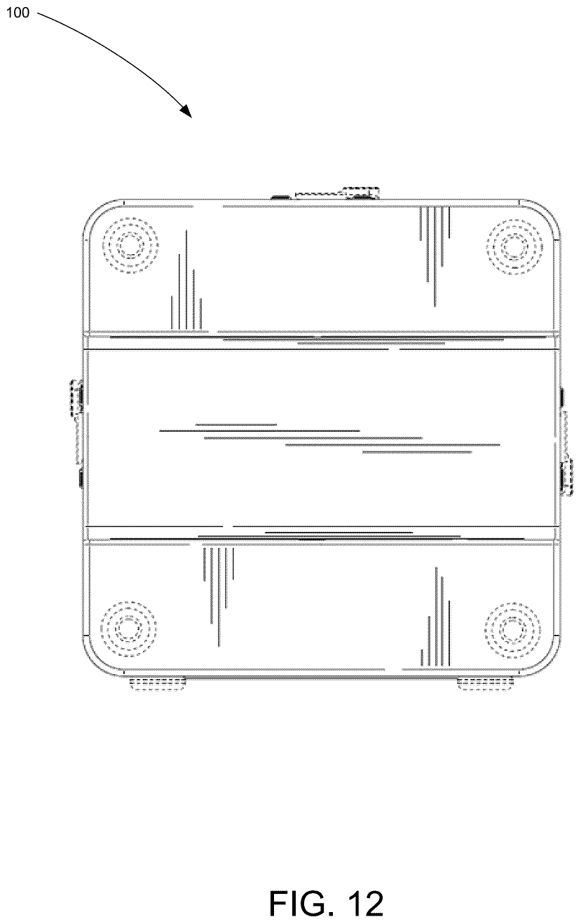

FIGS. 1-12 depict various views of one example air scrubber 100 according to one or more aspects described herein. And FIGS. 2 and 4 depict the air scrubber 100 having certain portions removed so that the air scrubber 100 can be more easily understood.

As shown in FIGS. 1-5 the air scrubber 100 includes an outer shell 102. The outer shell 102 can include a first sidewall 104 having a first aperture 106; a second sidewall 108 having a second aperture 110; a third sidewall 112 having a third aperture 114; a fourth sidewall 116; a top wall 118; and a bottom wall 120. As shown in FIGS. 1-5 the four sidewalls and top and bottom walls generally form a box shape. However, in other embodiments, the air scrubber 100 may have more or less side walls and top and bottom walls. As shown in FIGS. 1-5 the top wall 118 may be recessed from an upper edge of the sidewalls 104, 108, 112, 116. Similarly, the bottom wall 118, or part of the bottom wall, may be recessed from a lower edge of the sidewalls 104, 108, 112, 116. As shown in FIGS. 1-5 the bottom wall may include feet 136 configured to allow the air scrubber 102 to stand on the feet 136. The feet may be formed of a rubber or plastic material capable of absorbing vibrations from the air scrubber 100. Similarly, one or more of the sidewalls 104, 108, 112, 116 may include feet 134 which can allow a user to stand the air scrubber in different configurations. Thus, a user can choose the preferred orientation to setup the air scrubber and air can exhaust upward or outward depending on the orientation of the air scrubber.

As shown in FIGS. 1-5 the fourth sidewall 116 of the air scrubber 102 may include a cord retainer 130 configured to retain an electrical cord 132 wrapped around the cord retainer. Additionally, one or more of the upper and/or lower edges of the sidewalls 104, 108, 112, 116 may include recessed portions, and as shown in FIGS. 1-5 one or more of the sidewalls 104, 108, 112, 116 may include handles so that a user can more easily grip and move the air scrubber 100.

The outer shell 102 may be formed of a single integral piece. In one example, the outer shell may be molded of single integral piece. In a more specific example, the outer shell may be rotomolded as a single integral piece and it may be formed of plastic material including Linear Low Density Polyethylene (LLDPE) Medium Density Polyethylene (MDPE) High Density Polyethylene (HDPE) Low Density Polyethylene (LDPE).

The apertures 106, 110, and 114 may be sized to accept a filter (not shown in FIGS. 1-12). More specifically, the apertures 106, 110, and 114 may be sized to fit a standard HVAC filter. Standard HVAC filters can have various sizes including, for example, 12″×12″×1″, 10″×20″×1″; 14″×20″×1″; 16″×24″×1″; 18″×30″×1″, 12″×24″×1″. In one embodiment, the air scrubber 100 may have an overall height of 26-29 inches and an overall width of 16-19 inches, but the air scrubber can be sized to fit any size filter. The filters can be installed into the outer shell 102 and then locked in place with a filter cover. More specifically, the air scrubber 100 may also a first filter cover 122 configured to engage the first sidewall 104 and substantially cover the first aperture 106 and hold a filter in place; a second filter cover 124 configured to engage the second sidewall 108 and substantially cover the second aperture 110 and hold a filter in place; and a third filter cover 126 configured to engage the third sidewall 112 and substantially cover the third aperture 114 and hold a filter in place. The filter covers 122, 124, and 126 my be locked in place using various locking structures including turn-locks 138 as shown in FIGS. 1-5.

As shown in FIGS. 1-5, the air scrubber 102 may also include a fan 128 or other device to move air. The fan 128 may be engaged with the top wall 118 and it may be configured to move air inward through each of the first aperture 106, the second aperture 110, and the third aperture 114 and outward from the top wall 118. Thus, the fan 128 forces air through each filter engaged in the first aperture 106, the second aperture 110, and the third aperture 114. Thus, air which is exhausted from fan 128 through the top wall 118 is substantially filtered compared to air entering the first aperture 106, the second aperture 110, and the third aperture 114. The fan 128 may also include a switch 142 with one or more speed settings to control the speed of the fan.

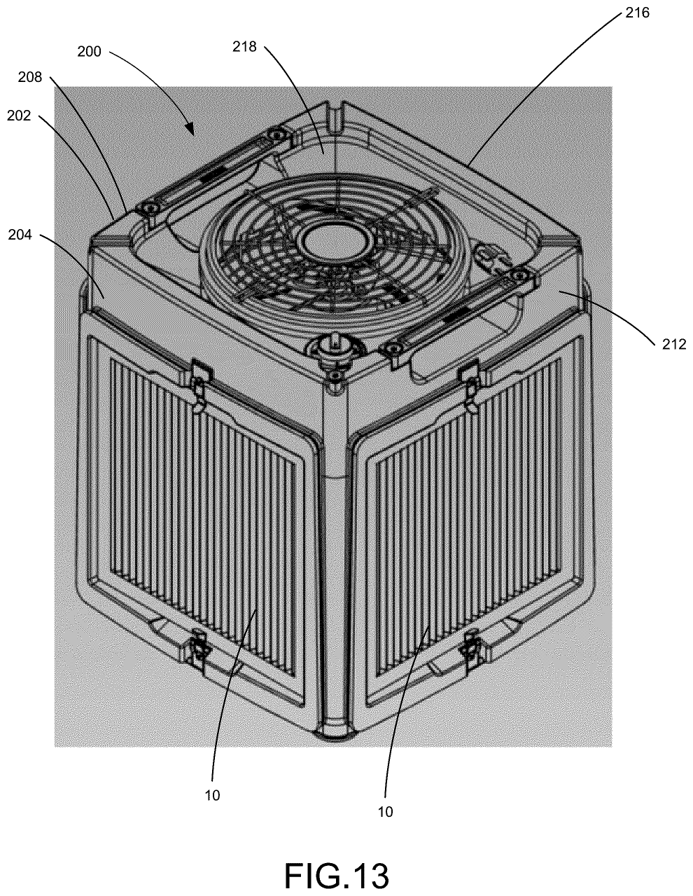

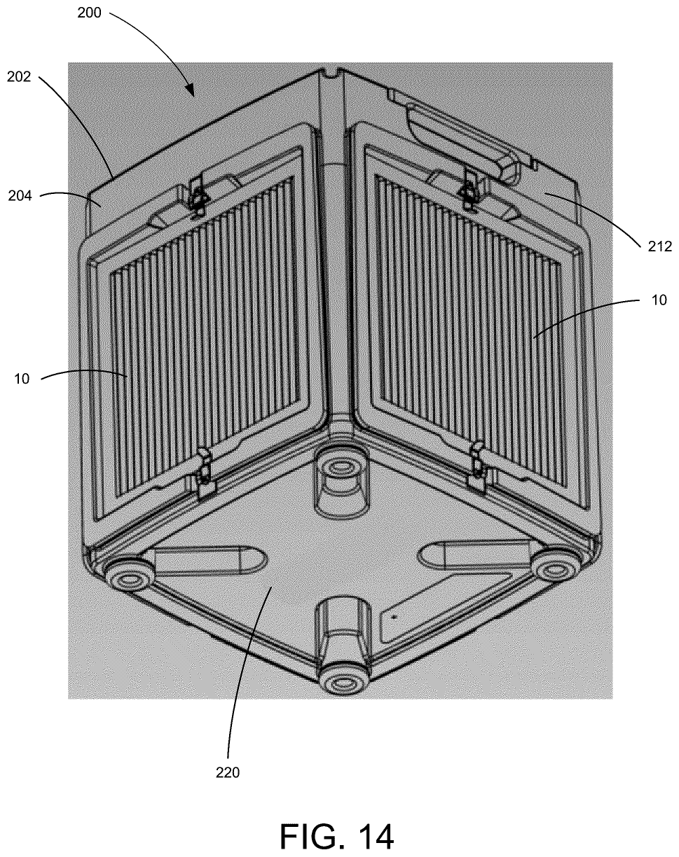

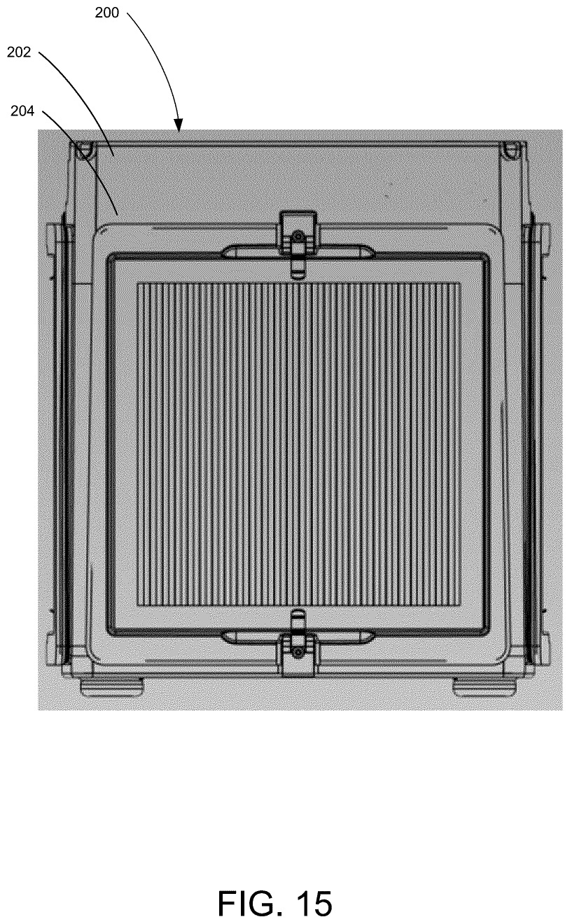

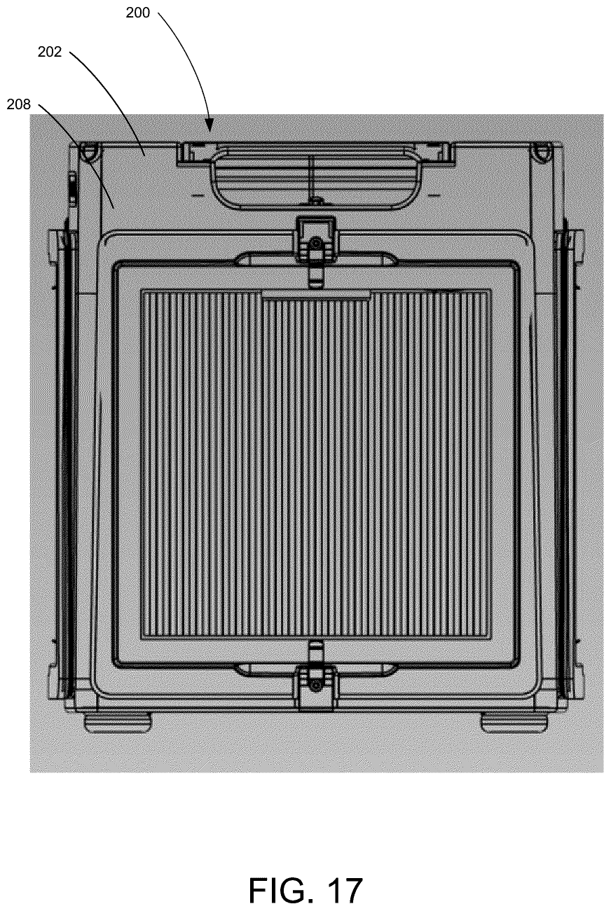

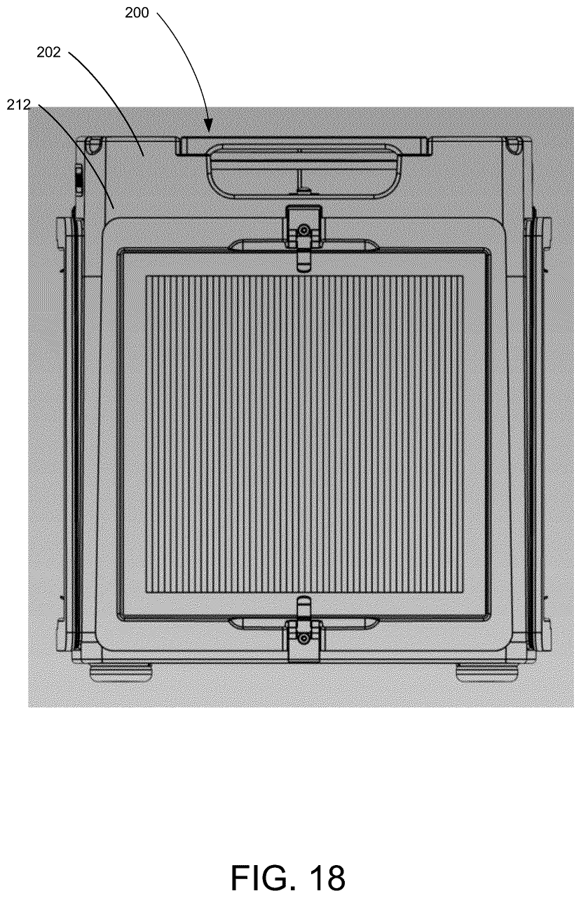

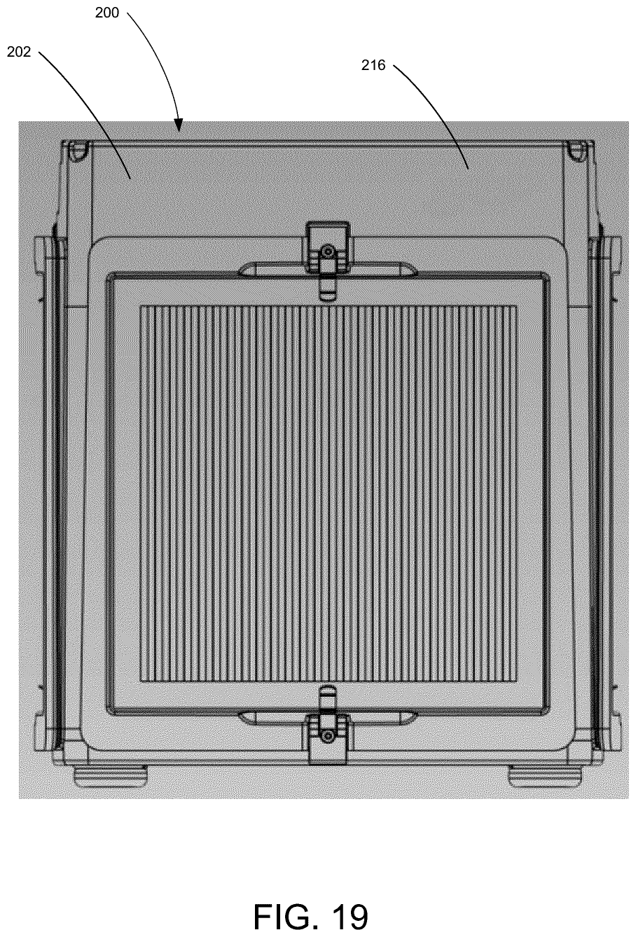

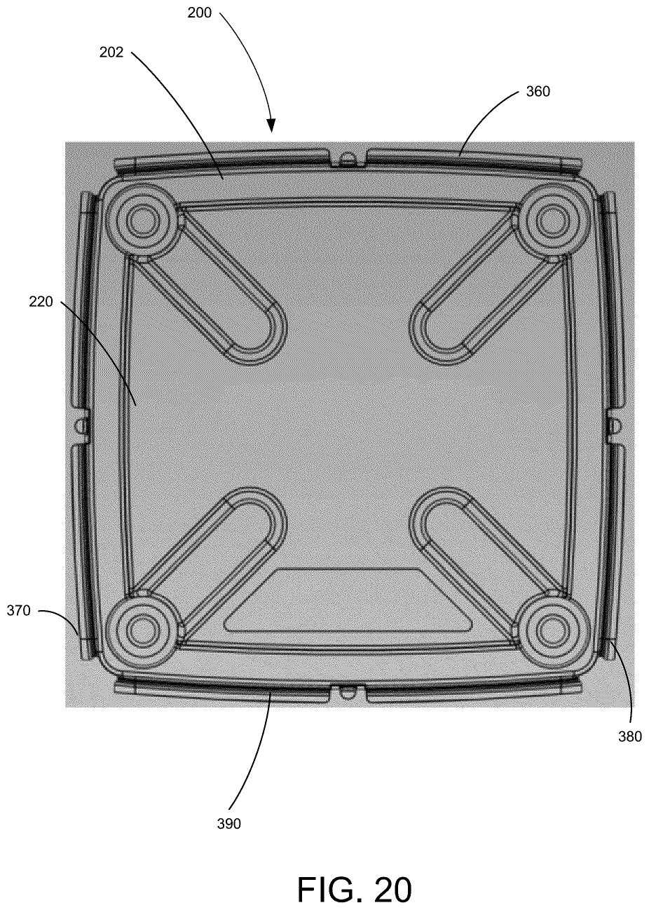

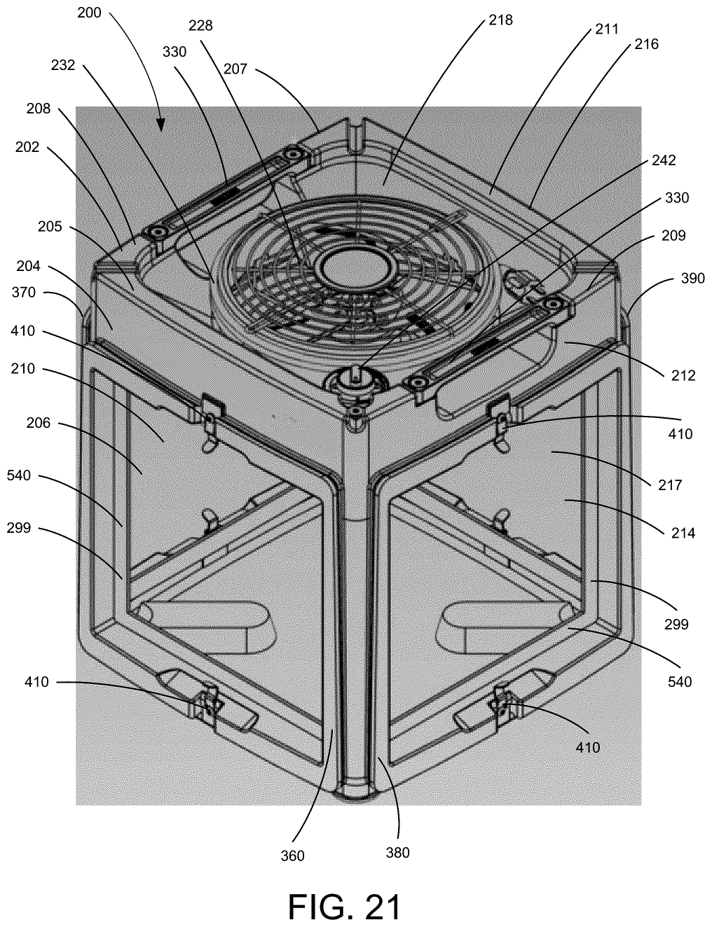

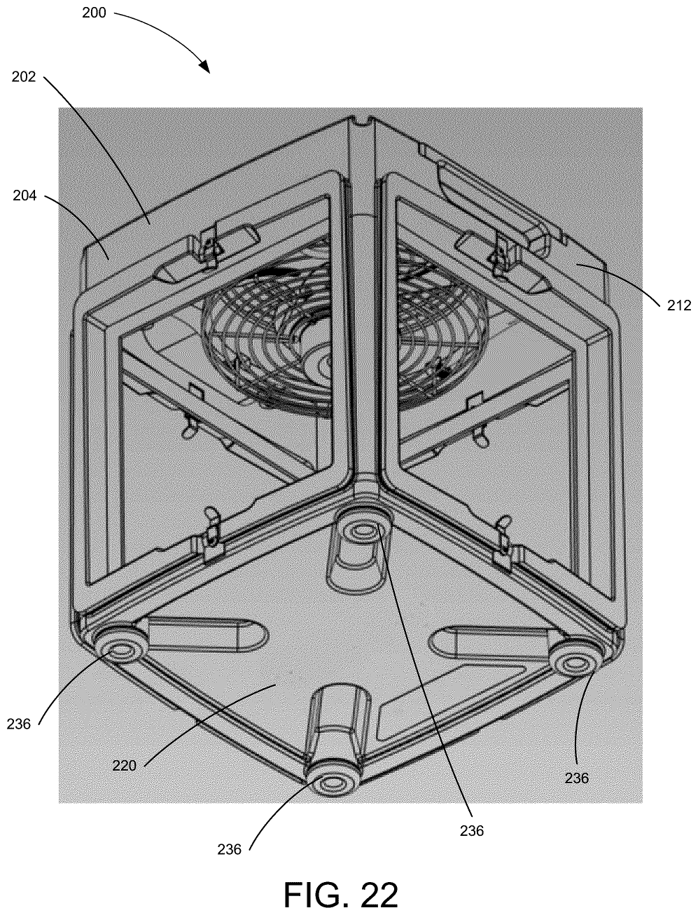

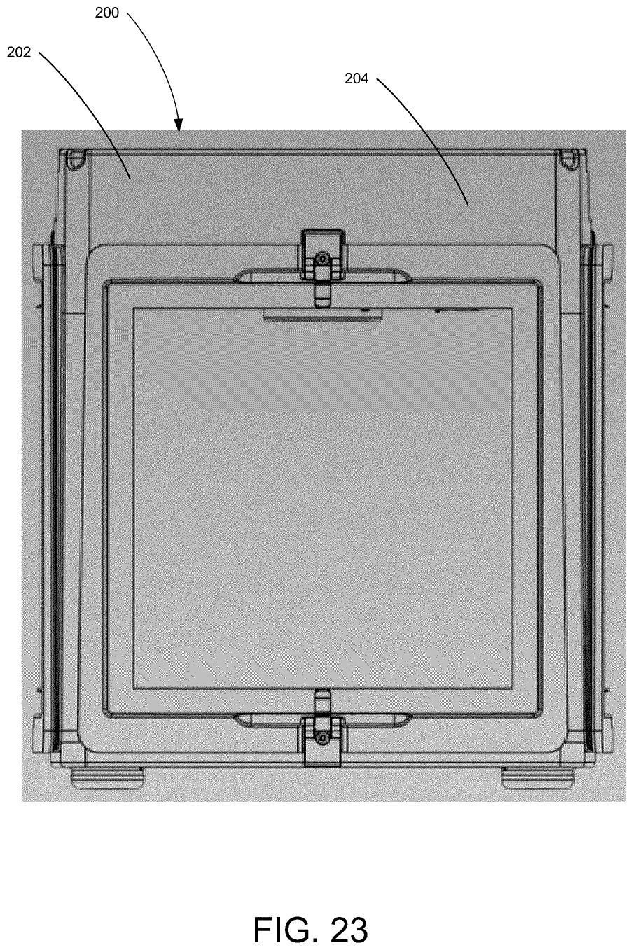

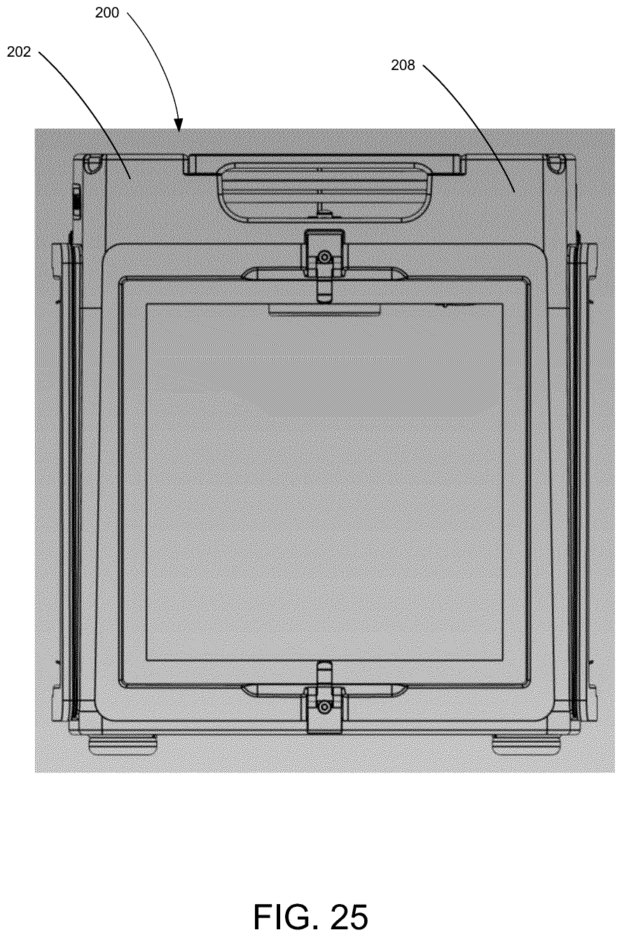

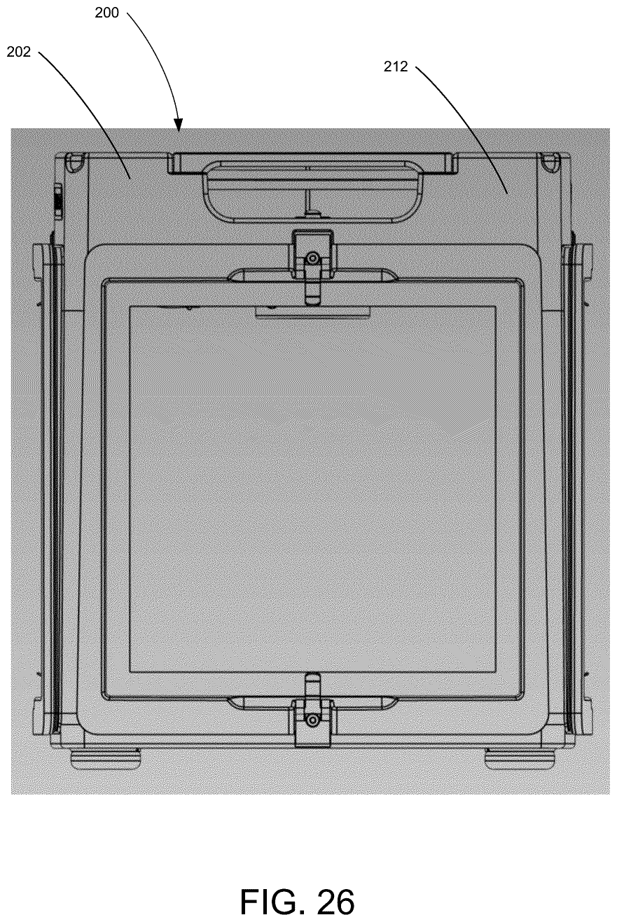

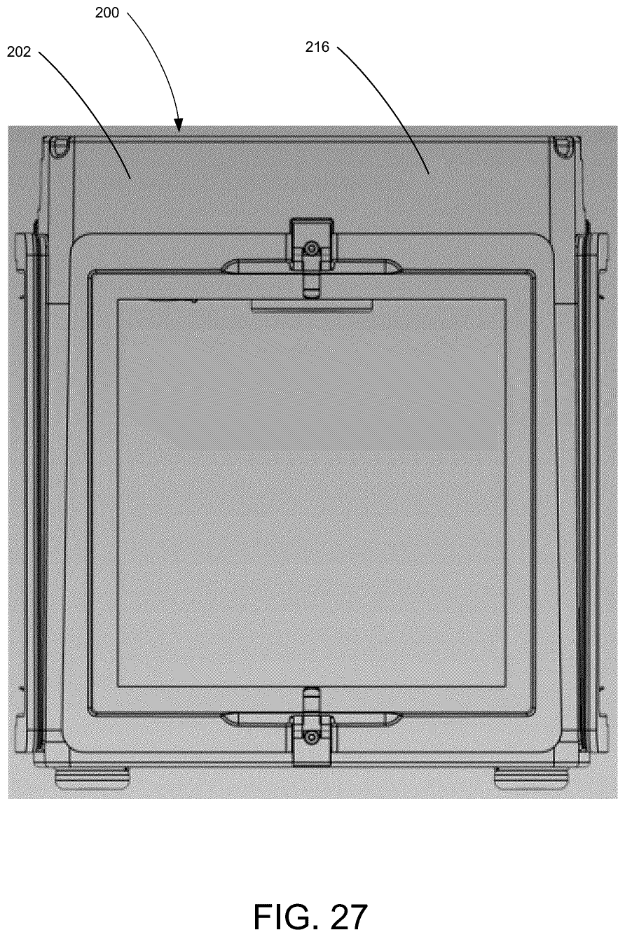

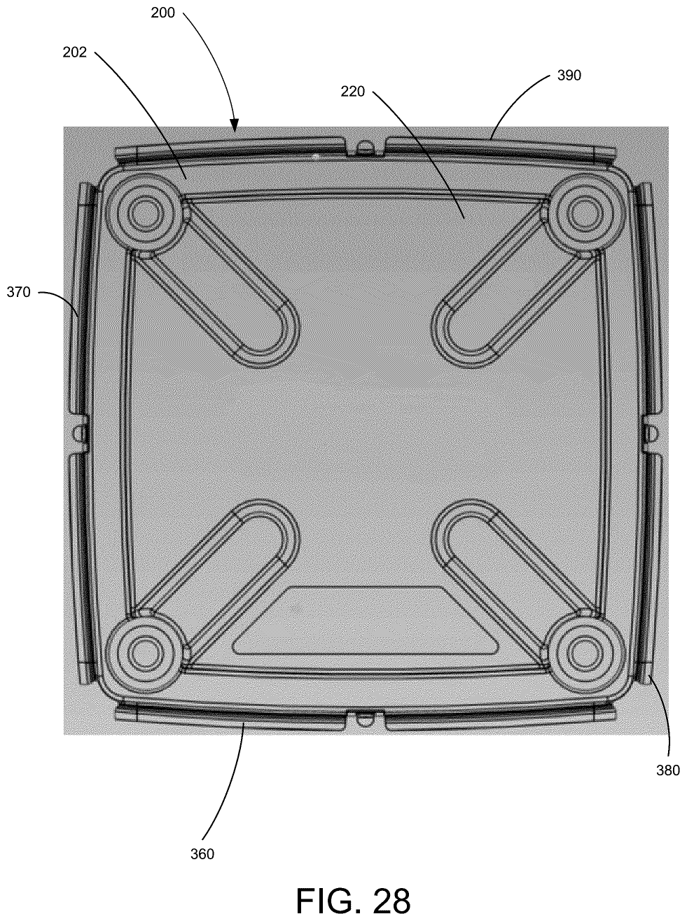

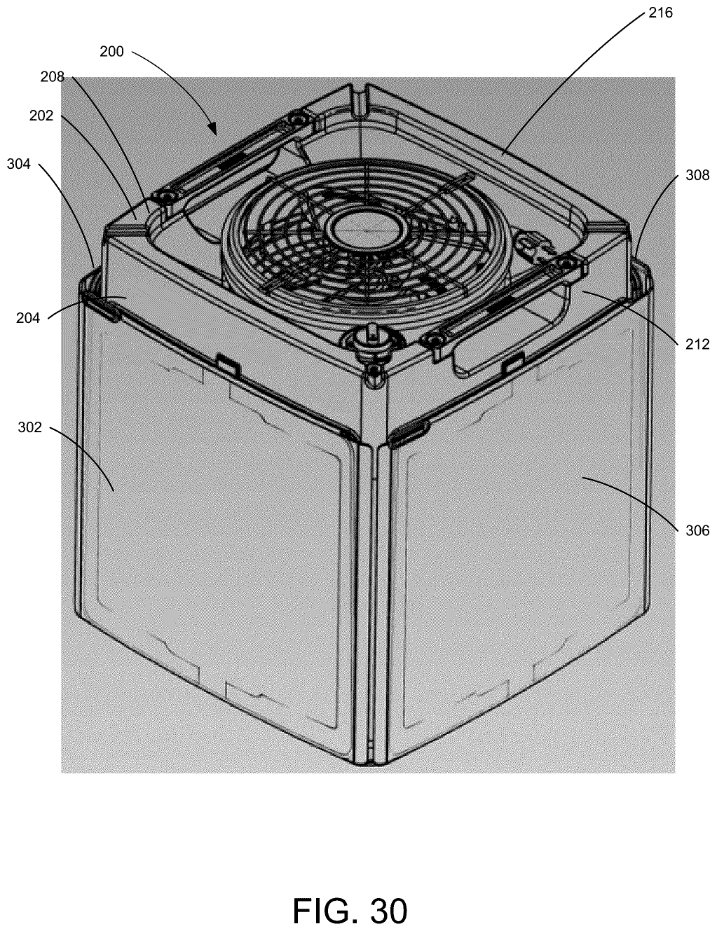

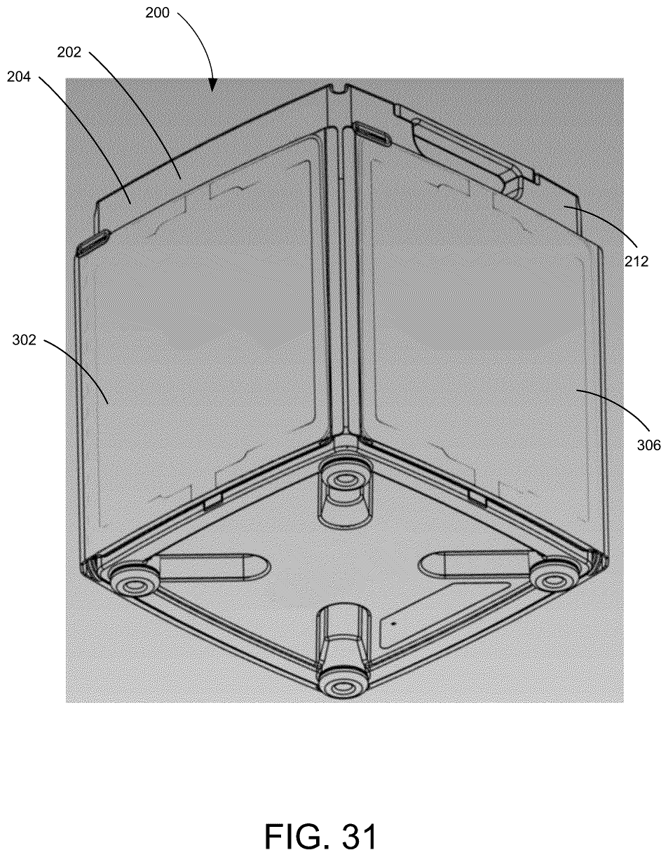

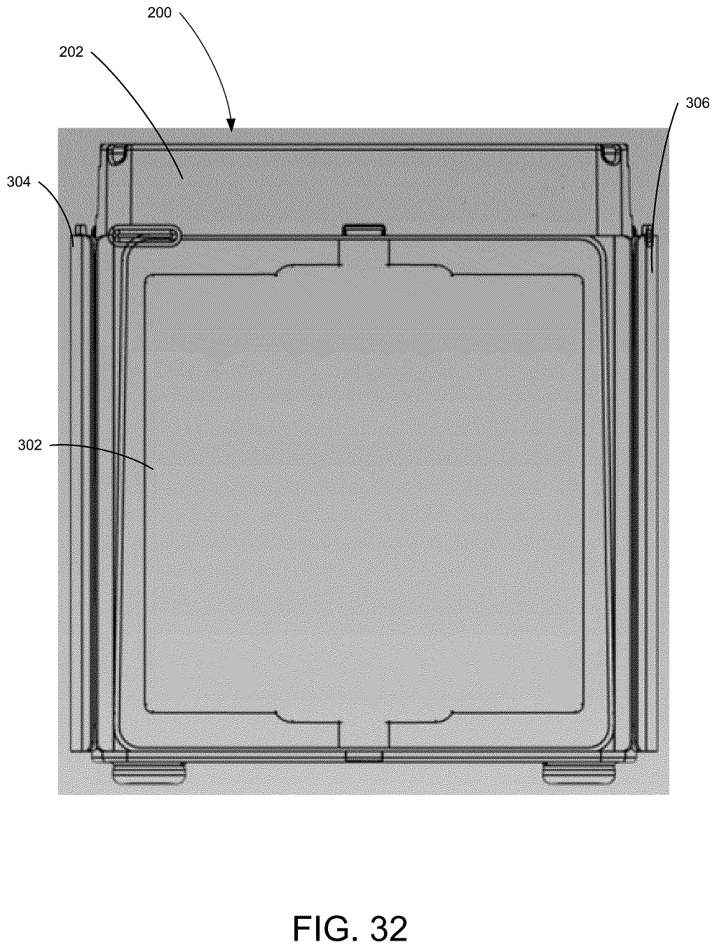

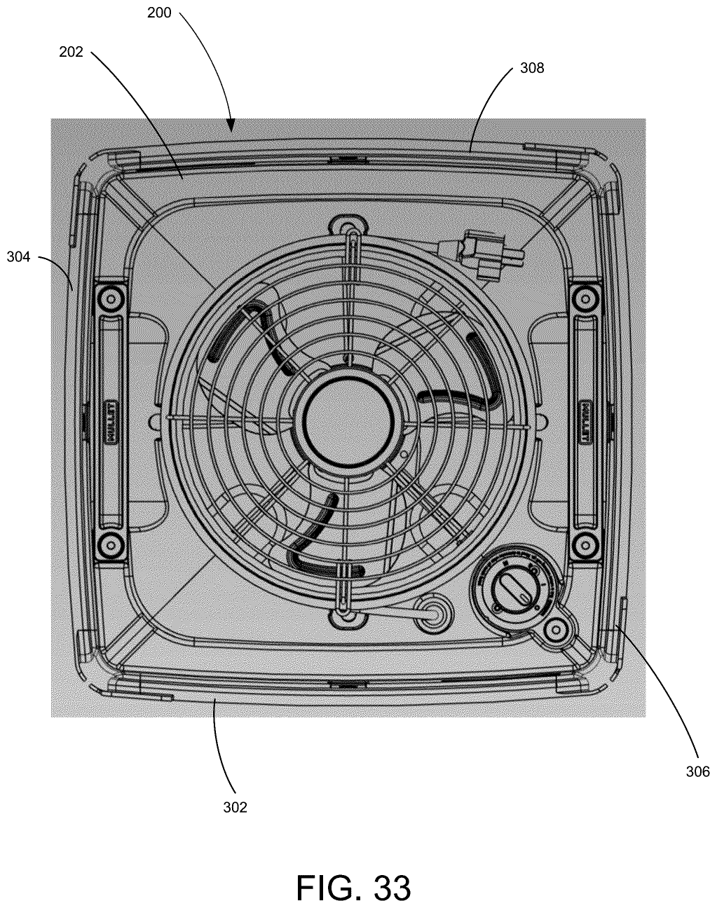

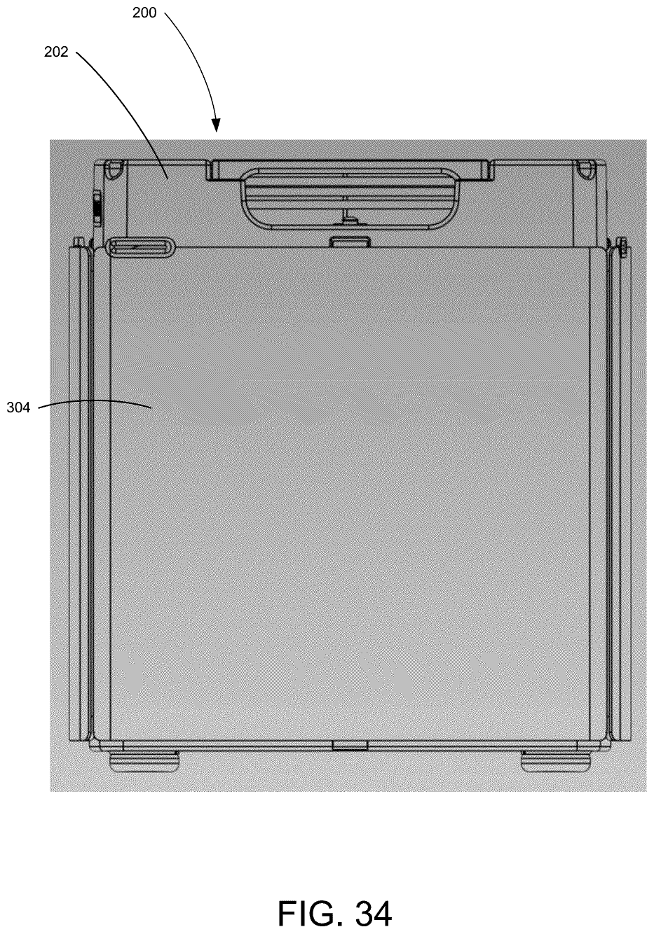

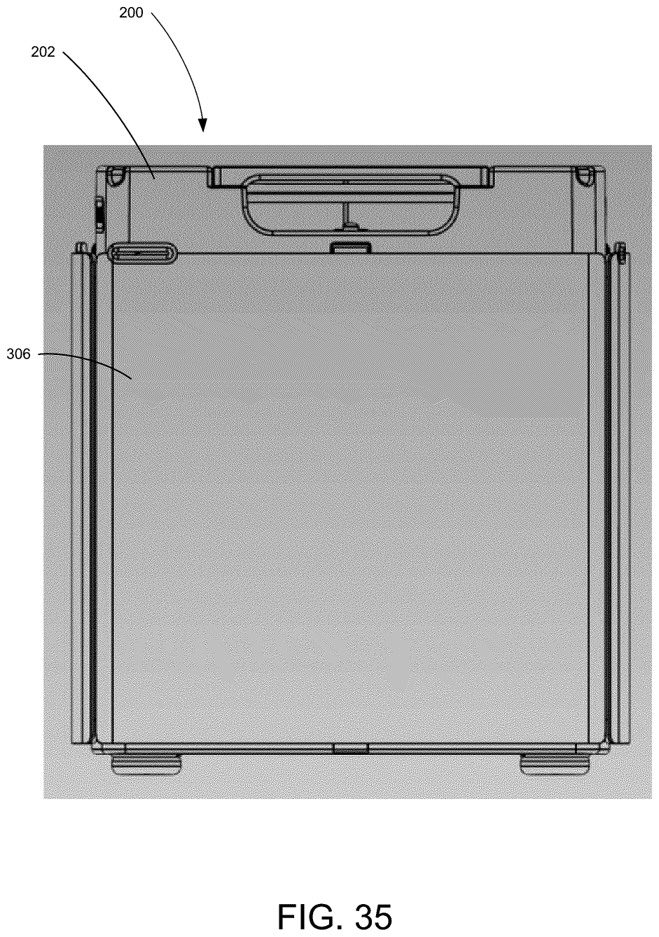

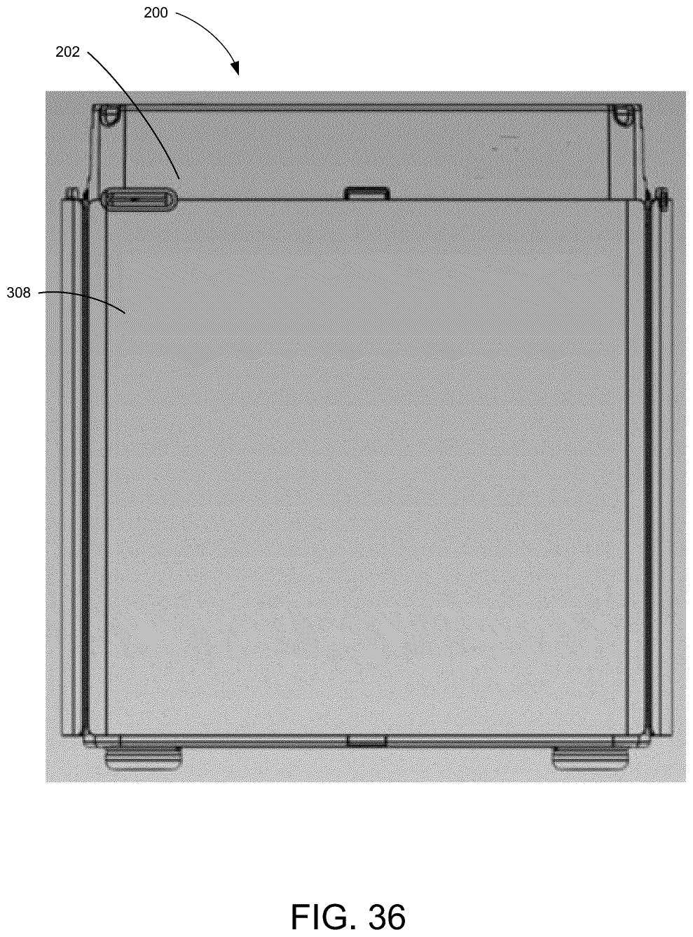

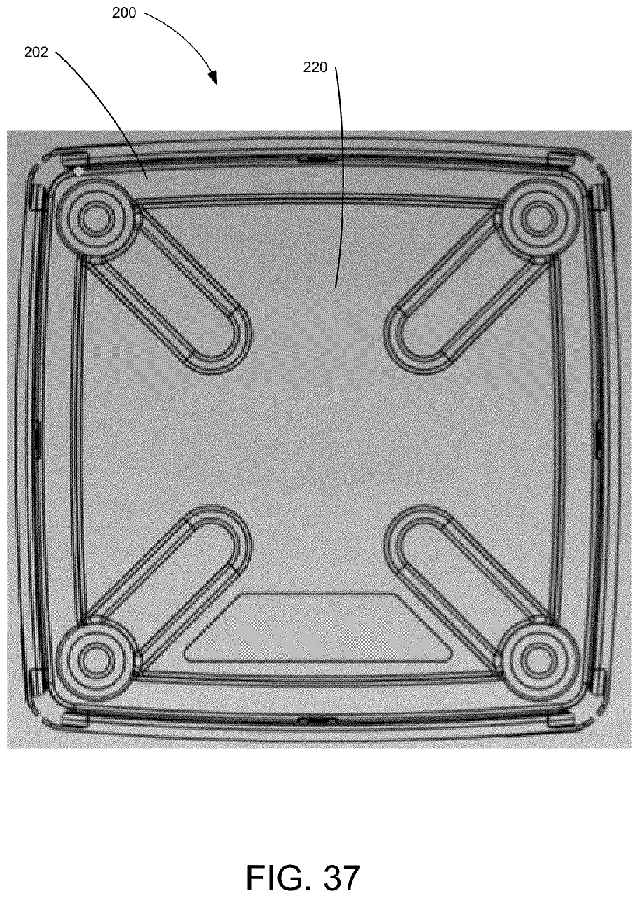

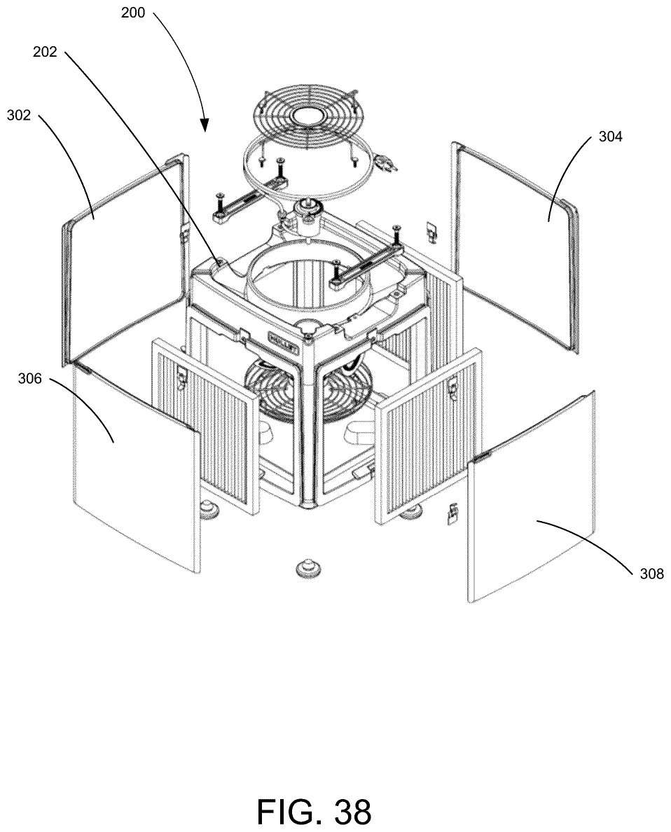

FIGS. 13-38 show another embodiment of an air scrubber 200 according to aspects described herein. The air scrubber 200 is similar to the embodiment shown in FIGS. 1-12, but, as will be described in greater detail below, it includes differing features including a fourth sidewall having a fourth aperture and it does not include filter covers. However, the features described with regard to air scrubber 100 may be incorporated into the air scrubber 200 and the features described with regard to air scrubber 200 may also be incorporated into the air scrubber 100.

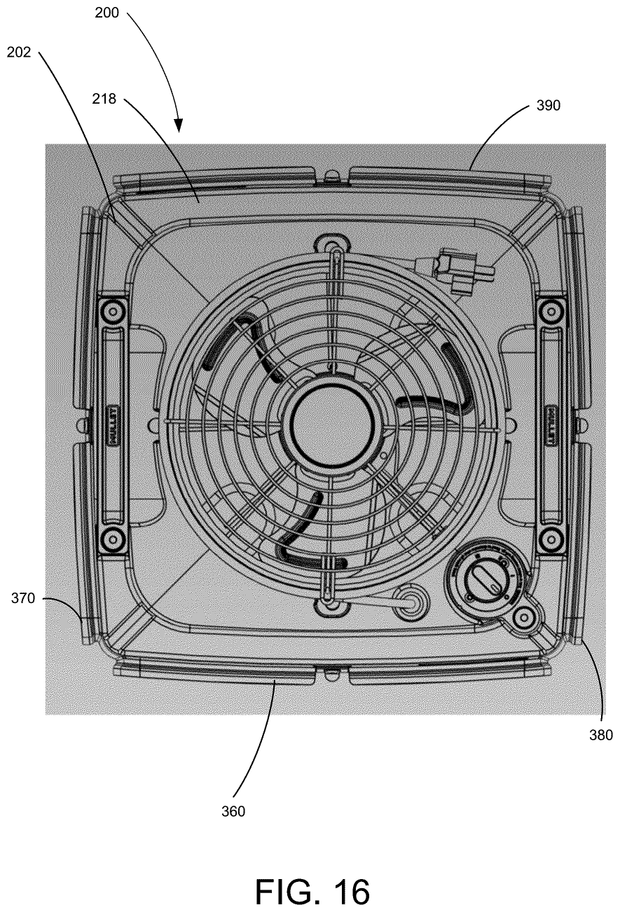

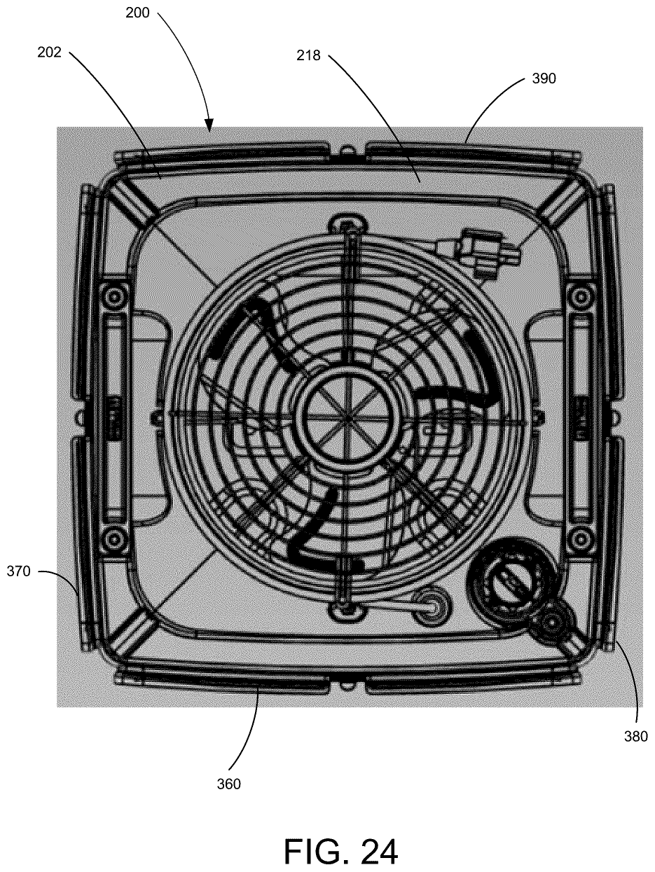

Similar to the air scrubber 100 shown in FIGS. 1-12, the embodiment of the air scrubber 200 shown in FIGS. 13-38 includes an outer shell 202. The outer shell 202 can include a first sidewall 204 having a first aperture 206; a second sidewall 208 having a second aperture 210; a third sidewall 212 having a third aperture 214; a fourth sidewall 216 and the fourth sidewall 216 can include a fourth aperture 217. The air scrubber 200 also includes a top wall 218 and a bottom wall 220. As shown in FIGS. 13-38 the four sidewalls and top and bottom walls generally form a box shape. However, in other embodiments, the air scrubber 200 may have more or less sidewalls and top and bottom walls. Additionally, as best shown in FIGS. 16 and 24, the sidewalls may bulge outward toward the center of the sidewall which can increase the strength of the outer shell 202.

As shown in FIGS. 13-38, the top wall 218 may be recessed from a top edge 205 of the first sidewall 204, a top edge 207 of the second sidewall 208, a top edge 209 of the third sidewall 212, a top edge 211 of the fourth sidewall 216. Similarly, the bottom wall 218, or part of the bottom wall, may be recessed from a lower edge of the sidewalls 204, 208, 212, 216. Advantageously, such recesses may allow a user to place items on top of the air scrubber without damaging the fan or other parts of the air scrubber. As shown in FIGS. 13-38, the bottom wall 220 may include feet 236 configured to allow the air scrubber 200 to stand on the feet 236. The feet may be formed of a rubber, silicone, plastic, or similar material capable of absorbing vibrations from the air scrubber 200 and which may also help in reducing movement of the air scrubber during use. Similarly, one or more of the sidewalls 204, 208, 212, 216 may include feet which can allow a user to stand the air scrubber in different configurations. Thus, a user can choose the preferred orientation to setup the air scrubber and air can exhaust upward or outward depending on the orientation of the air scrubber 200.

The outer shell 202 may be formed of a single integral piece. In one example, the outer shell may be molded of single integral piece. In a more specific example, the outer shell 202 may be rotomolded as a single integral piece and it may be formed of plastic material including Linear Low Density Polyethylene (LLDPE) Medium Density Polyethylene (MDPE) High Density Polyethylene (HDPE) Low Density Polyethylene (LDPE).

As shown in FIGS. 13-38, the apertures 206, 210, 214, and 217 may be sized to accept a filter 10. More specifically, the apertures 206, 210, 214, and 217 may be sized to fit a standard HVAC filter. Standard HVAC filters can have various sizes including, for example, 12″×12″×1″, 10″×20″×1″; 14″×20″×1″; 16″×24″×1″; 18″×30″×1″, 12″×24″×1″. In one embodiment, including the embodiment shown in FIGS. 13-38, the air scrubber 200 may have an overall height of 15-20 inches, an overall width of 14-20 inches, and an overall depth of 14-20 inches, but the air scrubber 200 can be sized to fit any size filter. The filters 10 can be installed in outer shell and one or more clips 410 can be configured to removably engage a filter in each of the first, second, third and fourth apertures 206, 210, 214, and 217. As shown in FIGS. 13-38, attached to the outer shell 202 around apertures 206, 210, 214, and 217 is a clip 410, and the clip 410 is configured to removably engage a filter within each of the apertures 206, 210, 214, and 217. As shown in FIGS. 13-38, the outer shell 202 may include a recessed edge 299 within each of the apertures 206, 210, 214, and 217 to engage an inside edge of the filters 10. In FIGS. 13-38. each aperture 206, 210, 214, and 217 includes a top clip and a bottom clip, but in other embodiments fewer or greater clips can be used. As shown in FIGS. 13-38, the air scrubber 200 does not include filter covers to retain the filter like the air scrubber 100. However, in other embodiments the air scrubber 200 may include filter covers to retain the filters. Similarly, while clips 410 are shown in FIGS. 13-38 to retain the filters 10, other engagement devices may be used include, for example, turn-locks, hook and loop fasteners, mechanical fasteners, and adhesive.

In some embodiments, the air scrubber may also include a gasket engaged with the outer shell 202 between the filter 10 and the outer shell 200 which may assist in forcing the flow of air through the filter 10. For example, the air scrubber can include a first gasket 540 engaged with the first sidewall 204 on the recessed edge 299 and configured to engage a filter engaged in the first aperture 206; a second gasket 540 engaged with the second sidewall 208 on the recessed edge 299 and configured to engage a filter engaged in the second aperture 210; a third gasket 540 engaged with the third sidewall 212 on the recessed edge 299 and configured to engage a filter engaged in the third aperture 214; and a fourth gasket 540 engaged with the fourth sidewall 216 on the recessed edge 299 and configured to engage a filter engaged in the fourth aperture 217.

As shown in FIGS. 13-38, the air scrubber 200 may also include a fan 228 or other device to move air. The fan 228 may be engaged with the top wall 218 and it may be configured to move air inward through each of the first aperture 206, the second aperture 210, the third aperture 214, and the fourth aperture 217 and outward from the top wall 218. Thus, the fan 228 forces air through each filter engaged each of the first aperture 206, the second aperture 210, the third aperture 214, and the fourth aperture 217. Thus, air which is exhausted from fan 228 through the top wall 218 is substantially filtered compared to air entering through each of the first aperture 206, the second aperture 210, the third aperture 214, and the fourth aperture 217. The fan 228 may also include a switch 242 with one or more speed settings to control the speed of the fan 228.

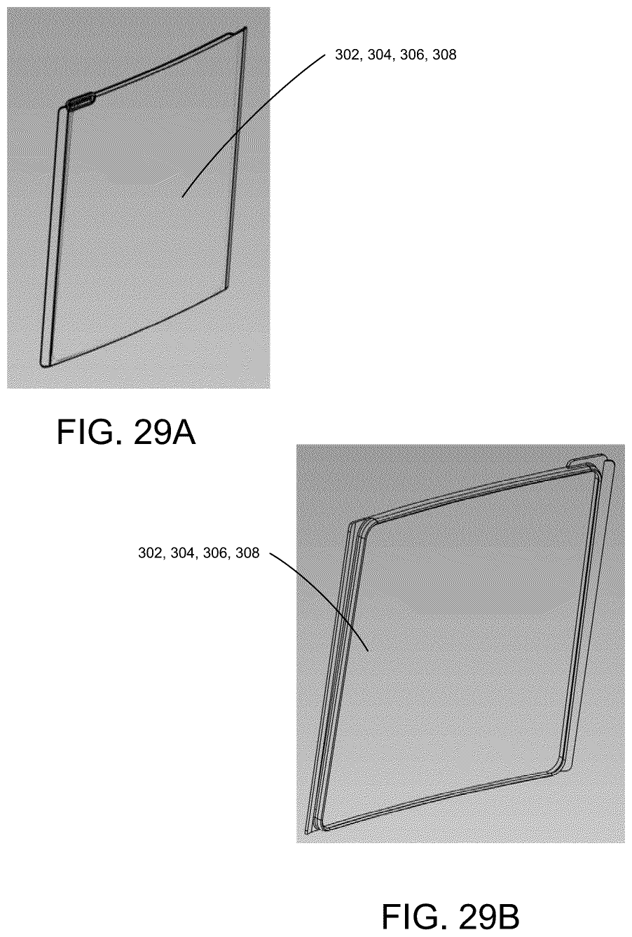

Advantageously, the air scrubber 100 and 200 may include aperture covers which a user may selectively use to cover one or more of the apertures during use of the air scrubber and/or during transport of the air scrubber. A user may cover one or more of the apertures during transport of the air scrubber to prevent captured or collected material from falling off of the filters. And a user may use one or more aperture covers during use of the air scrubber to direct air flow through the chosen apertures which will also increase air flow through the apertures that are not covered. The outside of an example aperture cover 302, 304, 306, 308 is shown in FIG. 29A and the inside of an example aperture cover 302, 304, 306, 308 is shown in FIG. 29B. As shown in FIGS. 13-38, the air scrubber 200 can include a first aperture cover 302 configured to engage the first sidewall 204 and substantially cover the first aperture 206; a second aperture cover 304 configured to engage the second sidewall 208 and substantially cover the second aperture 110; a third aperture cover 306 configured to engage the third sidewall 212 and substantially cover the third aperture 214; and a fourth aperture cover 308 configured to engage the fourth sidewall 216 and substantially cover the fourth aperture 217. The aperture covers 302, 304, 306, and 308 may be made of any suitable material that can substantially cover and seal the apertures. In one example, the aperture cover may be made of an ethylene propylene diene monomer rubber material. The aperture covers 302, 304, 306, and 308 may removably engage the outer shell 202 using any suitable method. As shown in FIGS. 13-38, the outer shell 202 may include a lip that the aperture covers 302, 304, 306, and 308 may removably engage. As shown in FIGS. 13-38, the air scrubber 200 may include a first lip 360 extending from the first sidewall 204 and surrounding at least a portion of the first aperture 206; a second lip 370 extending from the second sidewall 208 and surrounding at least a portion of the second aperture 210; a third lip 380 extending from the third sidewall 212 and surrounding at least a portion of the third aperture 214; and a fourth lip 390 extending from the fourth sidewall 216 and surrounding at least a portion of the fourth aperture 217. Each of the lips 360, 370, 380, 390 may entirely surround the corresponding aperture or may surround only a portion of the apertures. As shown in FIG. 29B, the inside of the aperture cover 302, 304, 306, 308 can include a lip corresponding to the lip 360, 370, 380, 390 of the outer shell 202 and configured to engaged the outer shell 202 lips 360, 370, 380, 390.

As shown in FIGS. 13-38 the top wall 218 of the air scrubber 102 may include a cord retainer 230 configured to retain an electrical cord 232 wrapped around the cord retainer, however, in other embodiments other walls including the sidewalls and bottom walls can include a cord retainer. Additionally, one or more of the upper and/or lower edges of the sidewalls 204, 208, 212, 216 may include handles 330 so that a user can more easily grip and move the air scrubber 200. In some embodiments the handles 330 may be integrally formed with the outer shell 202 and in other embodiments the handles 330 may be separately attached to the outer shell 202. Advantageously, the air scrubber 100, 200 may have a weight suitable for a user to easily move and transport the air scrubber. For example, in some embodiments, the air scrubber may have a weight in the range of 10 lbs to 20 lbs.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

1. An air scrubber comprising:
an outer shell comprising:
a first sidewall having a first aperture, the first aperture having a top edge, a bottom edge, a left edge, and a right edge;
a second sidewall having a second aperture, the second aperture having a top edge, a bottom edge, a left edge, and a right edge;
a third sidewall having a third aperture, the third aperture having a top edge, a bottom edge, a left edge, and a right edge;
a fourth sidewall having a fourth aperture, the fourth aperture having a top edge, a bottom edge, a left edge, and a right edge;
a top wall;
a bottom wall;
a first aperture cover configured to engage the first sidewall and substantially cover the first aperture;
a second aperture cover configured to engage the second sidewall and substantially cover the second aperture;
a third aperture cover configured to engage the third sidewall and substantially cover the third aperture;
a fourth aperture cover configured to engage the fourth sidewall and substantially cover the fourth aperture; and
a fan engaged with the top wall and configured to move air inward through each of the first aperture, the second aperture, the third aperture, and the fourth aperture outward through the top wall;
wherein each of the first aperture, the second aperture, the third aperture, and the fourth aperture have a height, width, and depth configured to engage a filter.

2. The air scrubber of claim 1 further comprising:
a first lip 360 extending from the first sidewall, the first aperture cover configured to engage the first lip;
a second lip extending from the second sidewall, the second aperture cover configured to engage the second lip;
a third lip 380 extending from the third sidewall, the third aperture cover configured to engage the third lip; and
a fourth lip extending from the fourth sidewall, the fourth aperture cover configured to engage the fourth lip.

3. The air scrubber of claim 2, further comprising:
a first clip configured to removably engage a filter within the first aperture;
a second clip configured to removably engage a filter within the second aperture;
a third clip configured to removably engage a filter within the first aperture; and
a fourth clip configured to removably engage a filter within the first aperture.

4. The air scrubber of claim 3, further comprising:
a first gasket engaged with the first sidewall 204 and configured to engage a filter engaged in the first aperture;
a second gasket engaged with the second sidewall and configured to engage a filter engaged in the second aperture;
a third gasket engaged with the third sidewall and configured to engage a filter engaged in the third aperture; and
a fourth gasket engaged with the fourth sidewall and configured to engage a filter engaged in the fourth aperture.

5. The air scrubber of claim 1, wherein the outer shell is molded as a single integral piece.

6. The air scrubber of claim 2, wherein the outer shell is rotomolded.

7. The air scrubber of claim 1, wherein the top wall is recessed below a top edge of the first sidewall, a top edge of the second sidewall, a top edge of the third sidewall, a top edge of the fourth sidewall.

8. The air scrubber of claim 1, wherein one of a first sidewall, the second sidewall, the third sidewall, and the fourth sidewall includes a handle.

9. The air scrubber of claim 1, wherein the top wall includes cord retainer configured to retain an electrical cord.

10. The air scrubber of claim 1, wherein the bottom wall is engaged with at least one foot.

11. The air scrubber of claim 1, wherein the air scrubber has a weight in the range of 10 lbs to 20 lbs.

12. The air scrubber of claim 1, wherein the first aperture cover the second aperture cover; the third aperture cover; and the fourth aperture cover are made of an ethylene propylene diene monomer rubber material.

13. An air scrubber comprising:
an outer shell comprising:
a first sidewall having a first aperture, the first aperture having a top edge, a bottom edge, a left edge, and a right edge;
a second sidewall having a second aperture, the second aperture having a top edge, a bottom edge, a left edge, and a right edge;
a third sidewall having a third aperture, the third aperture having a top edge, a bottom edge, a left edge, and a right edge;
a fourth sidewall having a fourth aperture, the fourth aperture having a top edge, a bottom edge, a left edge, and a right edge;
a top wall;
a bottom wall;
a first gasket engaged with the first sidewall and configured to engage a filter engaged in the first aperture;
a second gasket engaged with the second sidewall configured to engage a filter engaged in the second aperture;
a third gasket engaged with the third sidewall and configured to engage a filter engaged in the third aperture; and
a fourth gasket engaged with the fourth sidewall and configured to engage a filter engaged in the fourth aperture; and
a fan engaged with the top wall and configured to move air inward through each of the first aperture the second aperture, the third aperture, and the fourth aperture outward through the top wall;
wherein each of the first aperture, the second aperture, the third aperture, and the fourth aperture have a height, width, and depth configured to engage a filter.

14. The air scrubber of claim 13, wherein the top wall is recessed below a top edge of the first sidewall, a top edge of the second sidewall, a top edge of the third sidewall, a top edge of the fourth sidewall.

15. The air scrubber of claim 14, wherein the outer shell is molded as a single integral piece.

16. The air scrubber of claim 15, wherein the top wall recessed below a top edge of the first sidewall, top edge of the second sidewall, a top edge of the third sidewall, a top edge of the fourth sidewall.

17. The air scrubber of claim 16, wherein one of a first sidewall, the second sidewall, the third sidewall, and the fourth sidewall includes a handle.

18. The air scrubber of claim 17, wherein the air scrubber has a weight in the range of 10 lbs to 20 lbs.

19. The air scrubber of claim 18, wherein the bottom wall is engaged with at least one foot.

20. The air scrubber of claim 19, further comprising:
a first aperture cover configured to engage the first sidewall and substantially cover the first aperture;
a second aperture cover configured to engage the second sidewall and substantially cover the second aperture;
a third aperture cover configured to engage the third sidewall and substantially cover the third aperture; and
a fourth aperture cover configured to engage the fourth sidewall and substantially cover the fourth aperture.
